(19) United States
(12) Patent Application Publication
(10) Pub. No.: US 2016/0267420 A1
(43) Pub. Date: Sep. 15, 2016

(54) PROCESS MODEL CATALOG

(71) Applicant: HEWLETT PACKARD ENTERPRISE DEVELOPMENT LP, Houston, TX (US)

(72) Inventor: Peter Budic, San Diego, CA (US)

(21) Appl. No.: 15/033,160

(22) PCT Filed: Oct. 30, 2013
(86) PCT No.: PCT/US2013/067485

§ 371 Date: Apr. 29, 2016

(51) Int. Cl. G06Q 10/06

(52) U.S. Cl. CPC G06Q 10/06393; G06Q 10/0631

(57) ABSTRACT

Developing a process model catalog for operations management can include providing a user with a recommendation of at least one process model from a process model catalog based on an initiation request. It can further include creating a process plan based on a process model preference, receiving a modification to the process plan, and disseminating modifications to associated process entities. The process plan can be stored in the model catalog upon its completion and performance metrics associated with the process plan can be determined.

### BACKGROUND

Information Technology (IT) resources of an organization are managed in accordance with the needs and priorities of the organization. Managing the IT resources of an organization includes organizing and controlling aspects of the organization related to technology. For instance, IT processes can be managed, optimized, and reconfigured to accomplish business functions.

Managing the IT resources of an organization can include routine work following a common derived pattern. In other instances, managing the IT resources of an organization can include less predictable work with more variations in employee knowledge and skill involved in the management.

### BRIEF DESCRIPTION OF THE DRAWINGS

FIG. 1 is a diagram of an example of an environment for developing a process model catalog for IT operations management according to the present disclosure.

FIG. 2 illustrates a diagram of an example of a system for developing a process model catalog for IT operations management according to the present disclosure.

FIG. 3 illustrates a diagram of an example of a computing device according to the present disclosure.

FIG. 4 illustrates a flow chart of an example of a method for developing a process model catalog for operations management according to the present disclosure.

### DETAILED DESCRIPTION

Organizations utilize IT operations management systems to more efficiently organize, coordinate, and achieve IT operations meeting the needs of the organization. IT operations management systems approach optimizing operations (e.g., IT processes) from distinct methodologies.

IT operations management systems can be designed around a Business Process Management (BPM) methodology. An IT operations management system utilizing BPM methodologies can optimize operations by enforcing strong central processes and focusing on automation and efficiency. BPM methodologies are suited for highly predictable and highly repeatable operations. BPM methodologies can provide a highly defined process flow for an operation thereby providing repeatable processes through application of an existing model. Furthermore, IT operations management systems utilizing BPM methodologies allow collecting and reporting of performance metrics related to the structured process. BPM methodologies excel in process definition, but rely on an ad-hoc methodology for assigning work while data related to the process is spread across several distinct records in the system. IT operations management systems utilizing BPM methodologies produce optimal results with routine work, but struggle to produce acceptable and efficient results when handling knowledge work (e.g., work requiring dynamic processes, content, and/or rules). IT operations management systems utilizing BPM methodologies struggle with processes with too much variability to fit within a structured process model.

IT operations management systems can be designed around an Adaptive Case Management (ACM) methodology. An IT operations management system utilizing ACM methodologies can optimize operations by concentrating knowledge rather than focusing on automation and efficiency. ACM methodologies may provide little or no predefined process flow, but concentrate data related to a particular process outcome to support unstructured knowledge work. IT operations management systems utilizing ACM methodologies produce optimal results with unstructured, unpredictable, and unrepeatable knowledge work. However, IT operations management systems utilizing ACM methodologies often include a significant cost/resource burden on an organization and amplify inefficiencies when applied to routine highly-repeatable processes. Additionally, while the IT operations management systems that utilize ACM methodologies excel in bringing data for completing a process to a user, the unstructured process is a hindrance to collecting and reporting performance metrics.

In contrast, in accordance with various examples of the present disclosure, an IT operations management system can define operations within a process in an adaptive manner, but define the overall process in a formulaic manner allowing for the collection and reporting of performance metrics related to the process. Various examples of the present disclosure provide an adaptable and elastic IT operations management system for IT operations staff to manage both routine/repeatable processes and well as unknown and unexpected events. The IT operations management system of the present disclosure can include a process model catalog form which to provide users with a number of process models to address the user's initiation request. The IT operations management system can create a process plan (in some instances a blank process plan) based on the user's process model preference. The IT operations management system can receive modifications to the plan and disseminate data to process plan entities. The IT operations management system can store the process plan in the model catalog upon its completion and determine/report performance metrics associated with the process plan.

An IT operations management system, as used herein, can include a service manager (e.g., an application, a software suite, a cloud based service, etc.) providing (e.g., to IT operations users, to IT operations managers, etc.) core capabilities associated with IT services of an organization. The IT operations management system can be utilized to create, maintain, and task out the work associated with IT operations management. For example, the IT operations management system can provide resources for addressing common IT processes areas (e.g., incident management, problem management, change management, request management, release management, etc.) of the organization.

A process model, as used herein, can include a set of one or more prescribed processes (e.g., IT processes, etc.) to perform desired actions. The prescribed processes can include a set of one or more tasks and/or dependencies used to complete a type of IT process (e.g., incident management, problem management, change management, request management, release management, etc.) for an IT service (e.g., a change request to add more storage to an email box of an employee within the organization). Additionally, the process model can include and/or define data relevant to completion of the process, but that is not regularly part of the IT process in question (e.g., storage and server addresses utilized as email account storage). The process model can include and/or be associated with a process plan.

A process plan, as used herein, can include a modifiable set of one or more tasks and/or dependencies used to complete a type of IT process derived from a process model. In some instances, the process plan is not derived from a process model, but is a loosely structured and/or blank process plan which is not specific to a type of IT process for an IT service. Additionally, the process plan can include and/or define data relevant to completion of the process, but that is not regularly part of the IT process in question. These important data can be added to the process plan and/or read or written to by any task in the process plan.

A user, as used herein, can include a number of users of the IT operations management system. The users can submit requests to the IT operations management systems. The users also can be responsible for multiple IT operations within the system. As used herein, the term user may refer to a computing device associated with a human user.

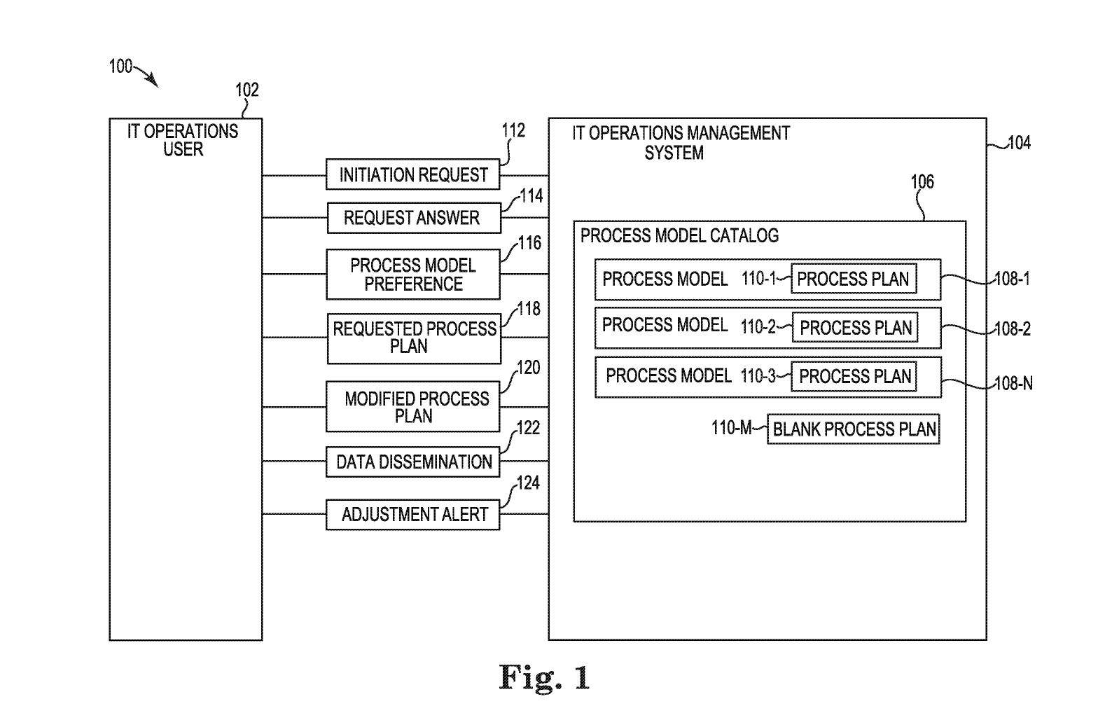

FIG. 1 is a diagram of an example of an environment 100 for IT operations management according to the present disclosure. The environment 100 can include an IT operations user 102 and an IT operations management system 104. The IT operations user 102 can be a user of the IT operations management system 104. For example, the IT operations 102 user may be an employee of an organization who is requesting an IT operation (e.g., additional email storage). The IT operations user 102 can include IT personnel of the organization tasked with fielding employee requests and utilizing the IT operations management system 104 to satisfy the requests. The IT operations user 102 can be responsible for many distinct IT operations. The IT operations user 102 can include hardware and/or software monitoring system events and reporting the system events to the IT operations management system 104.

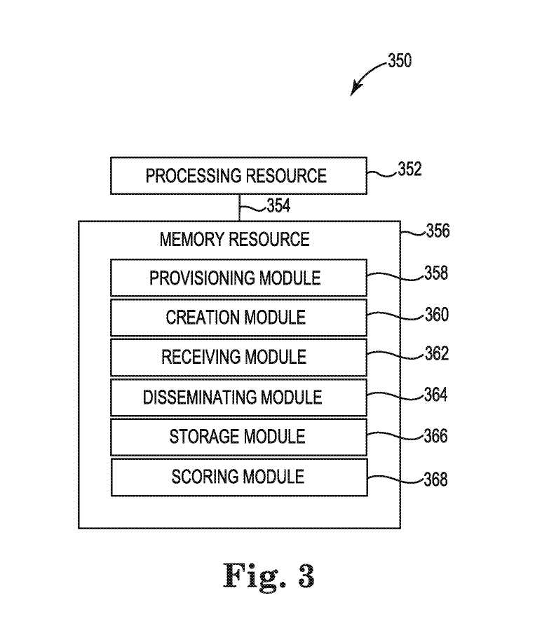

The IT operations management system 104 can include an application to create, maintain, and/or task out IT operations deployed on a computing device (e.g., a computing device as described in connection with FIG. 3) for instance. The IT operations management system 104 can include a process model catalog 106. The process model catalog 106 can be a catalog of process models 108-1, 108-2, . . . 108-N. The process models 108-1, 108-2, . . . 108-N can be associated with and/or include a process plan (e.g., 110-1, 110-2, 110-3). The process models 108-1, 108-2, . . . 108-N can additionally include indications of the service type and process type of the process models 108-1, 108-2, . . . 108-N. Service type can include the organizationally defined service or utility of the organization that is the target of the process model 108-1, 108-2, . . . 108-N (e.g., email service, mobile communication service, etc). Process type can include the classification (usually known by the IT operations user 102) of the IT process at the core of the process model 108-1, 108-2, . . . 108-N (e.g., incident process, problem process, change process, request process, release process, etc.).

The process plans (e.g., 110-1, 110-2, 110-3) can be a modifiable number of processes including a modifiable number of process entities (e.g., tasks, dependencies, associated data, etc.) derived from particular process models 108-1, 108-2, . . . 108-N. Therefore, a process plan (e.g., 110-1, 110-2, 110-3) can, in some examples, be a modifiable version of a process model 108-1, 108-2, . . . 108-N. In various examples, the process plan can be a blank process plan 110-M. A blank process plan 110-M can be a modifiable number of process entities (e.g., tasks, dependencies, associated data, etc.) not related to a particular process model 108-1, 108-2, . . . 108-N. A blank process plan 110-M can, in some examples, be related to accomplishing a particular IT operation or class of IT operations, but may not be specific to a particular process model 108-1, 108-2, . . . 108-N related to the operations. For example, the blank process plan 110-M can be related to managing a change request, but not derived from a process model (e.g., 108-1, 108-2, . . . 108-N) used to complete a change request to add more storage to an email account. In such examples, the blank process plan 110-M can be entirely blank or it may include general processes broadly related to change requests (e.g., the names and/or contact information for people on a change board deciding whether particular changes will be allowed).

The IT operations management system 104 can include an interface to receive inputs from and transmit outputs to the IT operations user 102 (e.g., directly to/from the user, to/from a computing device associated with the user, etc.). For example, the IT operations management system 104 can receive electronic representations of commands/data (e.g., initiation request 112) from the IT operations user 102 and/or transmit electronic representations of commands/data (e.g., request answer 114) to the IT operations user 102.

An initiation request 112 can include a signal indicating a request (e.g., a system event, a user service request, etc.), identifying the origin of the request (e.g., the identification of the employee issuing the request, the identification of the IT personnel handling the request, the identification of the hardware and/or software triggering a system event, etc.), and the content of the request (e.g., the IT operation being requested, a service type associated with the request, a process type associated with the request, etc.). The initiation request 112 can include a request from an IT operations user 102 that includes characteristics and/or descriptors of an operation (e.g., tags containing text/keywords descriptions of the operations) desired by the IT operations user 102. Alternatively, the characteristics and/or descriptors of an operation can be derived by the IT operations management system 104 from the initiation request 112 (e.g., through analysis of the service type, the process type, and/or other text/keywords of the initiation request 112). In various examples, the initiation request 112 can include a selection of a request type from a plurality of predefined request types. The plurality of predefined request types can be associated with the process model catalog 106. For example, the IT operations user 102 can be presented with a user interface displaying a number of menus (e.g., a number of drop down menus) of IT operations associated with the process models 108-1, 108-2, 108-N. The plurality of predefined request types can include a request type that is not associated with a process model 108-1, 108-2, . . . 108-N (e.g., a request type that does not yet have a related process model, a request type including an indication that the IT operations user 102 does not wish to use an existing process model 108-1, 108-2, . . . 108-N of the process model catalog 106, etc.).

The IT operations management system 104 can transmit a return answer 114 to the IT operations user 102. The return answer 114 can be in response to the initiation request 112. The return answer 114 can include a listing of a number of process models 108-1, 108-2, . . . 108-N. For example, the return answer 114 can include a presentation to the IT operations user 102 of a list of process models 108-1, 108-2, . . . 108-N from the process model catalog 106 for the IT operations user 102 to select from. The return answer 114 can include all of or less than all of the process models 108-1, 108-2, . . . 108-N in the process model catalog 106. The return answer 114 can include a recommendation. The recommendation can be a recommendation of a number of process models 108-1, 108-2, . . . 108-N expressed by including some of the process models 108-1, 108-2, . . . 108-N of the process model catalog 106. Which of the number of process models 108-1, 108-2, . . . 108-N of the process model catalog 106 are presented to the operations user 102 can be based on the initiation request. For example, the characteristics and/or descriptors included in the initiation request 112 can be compared to comparable characteristics and/or descriptors (e.g., descriptive tags based on service types, process types, and/or text/keywords of the process models 108-1, 108-2, . . . 108-N) related to the process models 108-1, 108-2, . . . 108-N stored in the process model catalog 106 and the particular process models 108-1, 108-2, . . . 108-N having similar enough characteristics and/or descriptors (e.g., tags exceeding a threshold number of matches) can be presented to the IT operations user 102 via the a return answer 114.

The recommendation can include an indication (e.g., a character, a numerical score, an ordering, etc.) associated with particular ones of a number of process models 108-1, 108-2, . . . 108-N included in the request answer 114. For example, the return answer 114 may include a number of process models 108-1, 108-2, . . . 108-N each with a recommendation score representing their respective fit with the initiation request 112 (e.g., quantification of the similarity between tags associated with the initiation request 112 and tags associated with the process model 108-1, 108-2, . . . 108-N). The recommendation score can also be based on performance metrics (as discussed later in this disclosure) associated with the number of process models 108-1, 108-2, . . . 108-N and their associated process plans 110-1, 110-2, 110-3.

The IT operations management system can receive a process model preference 116. The process model preference 116 can be received from the IT operations user 102. The process model preference 116 can include an indication of a preferred process model(s) of the number of process models 108-1, 108-2, . . . 108-N in the process model catalog 106. The process model preference 116 can include a selection by the IT operations user 102 of at least one of the number of process models 108-1, 108-2, . . . 108-N in the process model catalog 106 from a list of process models 108-1, 108-2, . . . 108-N included in the return answer 114. The process model preference 116 can include an indication from the IT operations user 102 that he wishes to proceed without specifying a particular process model of the number of process models 108-1, 108-2, . . . 108-N in the process model catalog 106. For example, the process model preference 116 can include an indication that the IT operations user 102 prefers to proceed utilizing a blank process plan 110-M. The IT operations user 102 may transmit such an indication if he is unable to find a suitable process model of the number of process models 108-1, 108-2, . . . 108-N in the process model catalog 106 to address the initiation request 112. For example, a blank process plan 110-M may be preferred when the initiation request 112 includes unstructured, unpredictable, and un-modeled IT operations (e.g., adaptive IT operations). In various examples, the process model preference 116 can be based on the recommendation included in the request answer 114. For example, the process model preference 116 can automatically select a suitable process model of the number of process models 108-1, 108-2, . . . 108-N in the process model catalog 106 based on a threshold and/or relative recommendation score being attained by a process model.

The IT operations management system 104 may create and/or retrieve a requested process plan 118 to make available to the IT operations user 102. Process plans 110-1, 110-2, 110-3 can include modifiable versions of process models 108-1, 108-2, . . . 108-N and/or modifiable blank process plans 110-M. Creating a requested process plan 118 can include copying tasks, dependencies and data fields from a process model 108-1, 108-2, . . . 108-N indicated in the process model preference 116 to a process plan 110-1, 110-2, 110-3. The process plan 110-1, 110-2, 110-3, . . . 110-M can be provided to the IT operations user 102.

The IT operations user 102 can execute the requested process plan 118 (e.g., perform the tasks specified in the process plan). Before, after, and/or during execution of the requested process plan 118, the IT operations user 102 can modify the requested process plan 118. For example, a modification can include adding a task, a dependency, and/or a definition of associated data to the requested process plan 118. The modification may include adding an additional task, dependency, definition of associated data, and/or additional required data to a requested process plan 118 that is based on a process model 108-1, 108-2, . . . 108-N and/or a requested process plan 118 that is not based on a process model 108-1, 108-2, . . . 108-N (e.g., a blank process plan 110-M). The modification may similarly include removing a task, a dependency, and/or a definition of associated data to the requested process plan 118. Additionally, the modification can include changing a task, dependency, and/or definition of required information to a requested process plan 118.

The IT operations management system 104 can receive modifications of the requested process plan 118 (e.g., as a modified process plan 120). The IT operations management system 104 can update task, dependency, and/or data fields associated with the requested process plan 118. For example, The IT operations management system 104 can save copies of the requested process plan (e.g., as a new process model) and/or modify or replace process models 108-1, 108-2, . . . 108-N from which the modified process plan 120 was originally derived.

The IT operations management system 104 can perform data dissemination 122. Data dissemination 122 can include collecting data associated with the modified process plan 120. The data may include data that the IT operations user 102 has added and/or modified in the modified process plan 120 (e.g., an input of the requested process plan 118 such as an email address of a new employee of the organization input while performing the process plan associated with the IT operation of setting up a new employee email). The data can also include data collected from other sources (e.g., organizational databases, system monitoring tools, etc.) which can be used as a definition in the modified process plan 120 (e.g., an employee ID number, retrieved from an organizational database, associated with the employee, wherein the employee ID number is a required defining input of the process plan associated with the IT operation of setting up a new employee email). Data dissemination 122 can include disseminating the collected data to the modified process plan 120 (e.g., providing inputs for the modified process plan 120 such as data associated with a number definitions required by the modified process plan 120. For example, the IT operations management system 104 can disseminate data to entities (e.g., tasks, dependencies, associated data, etc.) of the modified process plan 120 along with any related entities. For example, the collected data can be disseminated to process plans 110-1, 110-2, 110-3 related to (e.g., provide processes to accomplish a similar IT operation, contain similar and/or identical entities, are derived from the similar and/or identical process models, etc.) the modified process plan 120. The collected data can also be disseminated to related (e.g., provide processes to accomplish a similar IT operation, contain similar and/or identical entities, are derived from the similar and/or identical process models, etc.) process models 108-1, 108-2, . . . 108-N. Data dissemination 122 can generally include auto populating and auto updating any data utilized in a process plan 110-1, 110-2, 110-3, 110-M or modified process plan 120.

The IT operations user 102 can complete the process plan 110-1, 110-2, 110-3, 110-M or modified process plan 120. Completing may include executing the tasks until the process plan 110-1, 110-2, 110-3, 110-M or modified process plan 120 is complete (e.g., completing the IT operations requested in the initiation request 112). Upon completion, the IT operations user can update the process plan 110-1, 110-2, 110-3, 110-M or modified process plan 120 (e.g., modify/further modify the process plan 110-1, 110-2, 110-3, 110-M or modified process plan 120 to reflect steps needed to complete the plan in future applications) in order to improve efficiency of the plan based on their experience in utilizing it.

The IT operations management system 104 can store a process plan 110-1, 110-2, 110-3, 110-M or modified process plan 120 (e.g., in response to an indication from the IT operations user 102 to store the process plan 110-1, 110-2, 110-3, 110-M or modified process plan 120, automatically upon completing the process plan 110-1, 110-2, 110-3, 110-M or modified process plan 120, etc.). The IT operations management system 104 can store the process plan 110-1, 110-2, 110-3, 110-M or modified process plan 120 as new process models, replacements for the existing process models 108-1, 108-2, . . . 108-N, or modified versions of the existing process models 108-1, 108-2, . . . 108-N in the process model catalog 106. The stored process plan 110-1, 110-2, 110-3, 110-M or modified process plan 120 can then be analyzed in response to subsequent initiation requests 112 as a potential process model 108-1, 108-2, . . . 108-N for recommendation in a request answer 114. Additionally, a new initiation request 112 corresponding to a new process model can be generated and incorporated into subsequent lists of initiation requests 112 available to IT operations users 102.

The IT operations management system 104 can compile statistics on usage of process models 108-1, 108-2, . . . 108-N over time. The statistics can include key performance indicators (e.g., number of times each model was used, number of times a model was modified by an IT operations user 102 during a process, a percentage of times a process was completed successfully for each model, an average amount of time an IT operation took to complete for each model, etc.) The IT operations management system 104 can determine a number of performance metrics associated with a process model 108-1, 108-2, . . . 108-N. The performance metrics can be based on the key performance indicators. For example, the performance metric can be a score calculated from a function including the key performance indicators, wherein a higher score corresponds to better performing (e.g., frequently used, infrequently modified, higher completion percentage, lower average completion time, etc.) process models 108-1, 108-2, . . . 108-N relative to lower scoring process models 108-1, 108-2, . . . 108-N. The IT operations management system 104 can update the statistics and performance metrics each time the process model is utilized. The IT operations management system 104 can store the statistics and performance metrics associated with a process models 108-1, 108-2, . . . 108-N.

The IT operations management system 104 can utilize the statistics and performance metrics as part of developing recommendations of a process model 108-1, 108-2, . . . 108-N in response to an initiation request 112. For example, the IT operations management system 104 may recommend one process model 108-1, 108-2, . . . 108-N over another based at least in part on one achieving better performance metrics (e.g., a higher performance metric based score).

The IT operations management system 104 can utilize the statistics and performance metrics in order to identify sub-optimal process models 108-1, 108-2, . . . 108-N, IT personnel, IT training techniques, etc.

For example, the IT operations management system 104 can flag a process model 108-1, 108-2, . . . 108-N for adjustment (e.g., modification, removal, replacement, etc.) once its associated performance metrics fall below a predefined threshold value. The IT operations management system 104 can provide an adjustment alert 124 to the IT operations user 102 that the process model 108-1, 108-2, . . . 108-N has crossed a threshold and is subject to review and/or adjustment (e.g., adjustment of the process, adjustment of training practice associated with the process, etc.). The IT operations user 102 can then modify the process model 108-1, 108-2, . . . 108-N based on the performance metrics.

Additionally, the IT operations management system 104 can provide an adjustment alert 124 to an IT operations user 102 that a particular IT operations user 102 of a number of IT operations users is causing a performance metric of a number of process models 108-1, 108-2, . . . 108-N to fall below a predefined threshold value and may need corrective attention.

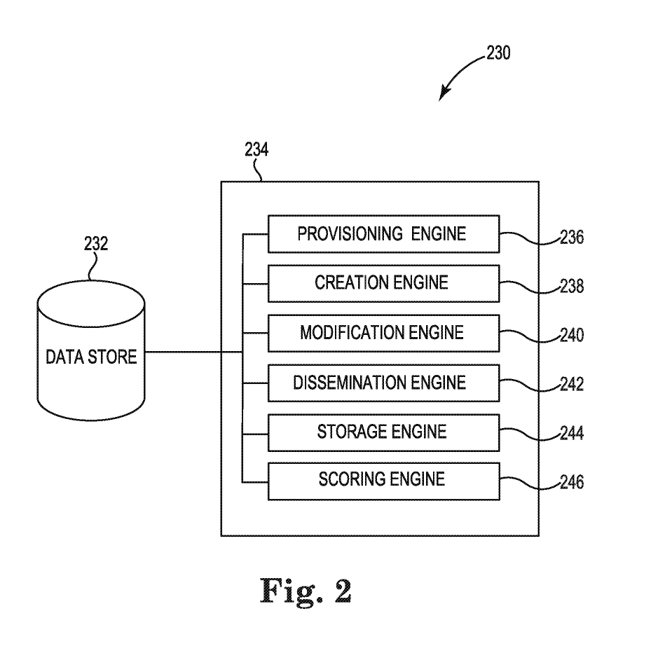

FIGS. 2 and 3 illustrate example systems 230 and 350 according to the present disclosure. FIG. 2 illustrates a diagram of an example of a system 230 for developing a process model catalog for IT operations management according to the present disclosure. The system 230 can include a data store 232, a management system 234, and/or a number of engines 236, 238, 240, 242, 244, 246. The management system 234 can be in communication with the data store 232 via a communication link, and can include the number of engines (e.g., provisioning engine 236, creation engine 238, modification engine 240, dissemination engine 242, storage engine 244, scoring engine 246, etc.). The management system 234 can include additional or fewer engines than illustrated to perform the various functions described herein.

The number of engines can include a combination of hardware and programming that is configured to perform a number of functions described herein (e.g., creating a process plan). The programming can include program instructions (e.g., software, firmware, etc.) stored in a memory resource (e.g., computer readable medium, machine readable medium, etc.) as well as hard-wired program (e.g., logic).

The provisioning engine 236 can include hardware and/or a combination of hardware and programming to provide a user with a recommendation of at least one of a number of process models returned from a model catalog. The recommendation can be based on an initiation request from the IT operations user. The initiation request can include a selection of a request type (e.g., add physical storage to an email account) from a plurality of request types (e.g., selected from a drop down menu of a plurality of request types) associated with the model catalog (e.g., the drop down menu is populated with a plurality of request types corresponding to the types of process models, associated service types, and/or process types of the process models the process model catalog).

The initiation request from the IT operations user can include a service type (e.g., email) and a process type (e.g., add physical storage to an email account). Each process model in the process model catalog can also be associated with a service type and a process model type. The recommendation can be based on a correspondence between the service types and/or process types of the initiation request and the process models. For example, the recommendation can include providing the user with a number of process models that are each associated with a score representing a the fit of the initiation request with that model (e.g., a score representing the amount of correspondence between the service types and/or process types of the initiation request and the particular process model).

A recommendation score associated with a process model can be based on the level of similarity between a first tag associated with the initiation request and a second tag associated with the process model being scored. For example the score can represent an amount of matching keyword tags associated with the initiation request and the process model being scored.

The recommendation score can be based on historical usage data of an existing process model of the number of process models from the model catalog. For example, if an IT operations user selects an “add physical storage to an email account” initiation request and that request matches three different process models equally in terms of keyword tags and/or service types and process types, the process model that has been most frequently utilized and/or executed to successful completion most frequently may receive a more favorable recommendation score.

The creation engine 238 can include hardware and/or a combination of hardware and programming to create a process plan for an information technology process based on a process model preference indicated by the IT operations user. The model preference can be in response to the recommendation and/or the providing of a number of process models associated with recommendation scores. The process plans can include a number of tasks, a number of dependencies, and a number of data fields associated with a preferred process model (e.g., a process model of the number of process models selected by the IT operations user). The process model can include a blank process plan in response to a process model preference of the IT operations user including an indication from the IT operations user to create the blank process plan without specifying a process model of the number of process models (e.g., an indication that the IT operations users finds none of the existing process models in the process model catalog sufficient to efficiently accomplish the IT operations user's IT operation).

The modification engine 240 can include hardware and/or a combination of hardware and programming to receive a modification to the process plan from an IT operations user. For example, the IT operations user may modify a number of tasks, dependencies, and/or data fields of the process plan before, during, and/or after execution of the plan. Where the IT operations user is proceeding with execution of a blank process plan, the modification to the blank process plan can include addition of a number of tasks, a number of dependencies, and a number of data fields to the blank process plans.

The dissemination engine 242 can include hardware and/or a combination of hardware and programming to disseminate data. For example, disseminate the modifications made by the IT operations user to a number of process plan entities (e.g., tasks, dependencies, and data fields) associated with the process model preference. For example, an IT operations user may input a new user's email address as a data field in a task of the process of setting up a new user. In such an example, that data can then be disseminated to other tasks within the process plan (e.g., auto-populated into a data field within a task for setting up email settings permissions for the user), to tasks in other process plans (e.g., auto-populated into a data field within a separate task for creating a roster with email contact information for employees working on a particular project), and/or to other sources (e.g., auto-populated into a data field in an employee database associating contact information with all employees).

The storage engine 244 can include hardware and/or a combination of hardware and programming to store the process plan in the process model catalog. The process model can be the modified process model. The storage can be in response to an IT operations user indication to store and/or in response to completion of the process plan (e.g., execution of a number of associated tasks).

Storing the process plan can include storing the process plan as a new process model in the process model catalog. Storing the process plan as a new process model in the process model catalog can include creating a new initiation request type corresponding to the new process model catalog. In this manner, the subsequent utilization of the IT operations management system can include the new initiation request in its plurality of initiation requests and the new process model in its recommendation.

The storage engine 244 can include hardware and/or a combination of hardware and programming to update the process plan. The update can be upon completion of the process plan. The update can include modifying the process plan to reflect steps needed to complete the process plan in a future application of the process plan. For example, an IT operations user can complete a process plan for expanding the physical memory for an employee's email box. In anticipation of many similar requests, but in consideration of a limited amount of physical storage, an IT operations user may decide that future requests may require permissions by an IT administrator. Therefore, the IT operations user can update the process plan for expanding the physical memory for an email box to include a task for seeking the necessary permissions.

The scoring engine 246 can include hardware and/or a combination of hardware and programming to determine a number of performance metrics (e.g., a score representing key performance indicators) associated with the process plan and/or process model. The number of performance metrics can be updated each time the process plan and/or process model is utilized. The process plan and/or process model can be flagged for modification when the associated number of performance metrics fall below a predetermined threshold (e.g., the score representing key performance indicators drops below a score representing a suboptimal performance threshold). Once a process plan and/or process model has been flagged for modification it can be modified based on the associated number of performance metrics (e.g., if the performance metrics indicate the process plan and/or process model is failing repeatedly at a particular task, the task may be modified to avoid the failure).

FIG. 3 illustrates a diagram of an example of a computing device 350 according to the present disclosure. The computing device 350 can utilize software, hardware, firmware, and/or logic to perform a number of functions herein.

The computing device 350 can be any combination of hardware and program instructions configured to share information. The hardware, for example, can include a processing resource 352 and/or a memory resource 356 (e.g., computer-readable medium (CRM), machine readable medium (MRM), database, etc.) A processing resource 352, as used herein, can include any number of processors capable of executing instructions stored by a memory resource 356. Processing resource 352 may be integrated in a single device or distributed across multiple devices. The program instructions (e.g., computer-readable instructions (CRI)) can include instructions stored on the memory resource 356 and executable by the processing resource 352 to implement a desired function (e.g., provide, based on an initiation request including a service type and a process type, a number of process models based on the service type and the process type, wherein each of the process models returned is associated with a score representing a respective fit within the initiation request.).

The memory resource 356 can be in communication with a processing resource 352. A memory resource 356, as used herein, can include any number of memory components capable of storing instructions that can be executed by processing resource 352. Such memory resource 356 can be a non-transitory CRM or MRM. Memory resource 356 may be integrated in a single device or distributed across multiple devices. Further, memory resource 356 may be fully or partially integrated in the same device as processing resource 352 or it may be separate but accessible to that device and processing resource 352. Thus, it is noted that the computing device 350 may be implemented on a participant device, on a server device, on a collection of server devices, and/or a combination of the user device and the server device.

The memory resource 356 can be in communication with the processing resource 352 via a communication link (e.g., a path) 354. The communication link 354 can be local or remote to a machine (e.g., a computing device) associated with the processing resource 352. Examples of a local communication link 354 can include an electronic bus internal to a machine (e.g., a computing device) where the memory resource 356 is one of volatile, non-volatile, fixed, and/or removable storage medium in communication with the processing resource 352 via the electronic bus.

A number of modules 358, 360, 362, 364, 366, 368 can include CRI that when executed by the processing resource 352 can perform a number of functions. The number of modules 358, 360, 362, 364, 366, 368 can be sub-modules of other modules. For example, the provisioning module 358 and the creation module 360 can be sub-modules and/or contained within the same computing device. In another example, the number of modules 358, 360, 362, 364, 366, 368 can comprise individual modules at separate and distinct locations (e.g., CRM, etc.).

Each of the number of modules 358, 360, 362, 364, 366, 368 can include instructions that when executed by the processing resource 352 can function as a corresponding engine as described herein. For example, the provisioning module 358 can include instructions that when executed by the processing resource 352 can function as the provisioning engine 236. In another example, storage module 366 can include instructions that when executed by the processing resource 354 can function as the storage engine 244.

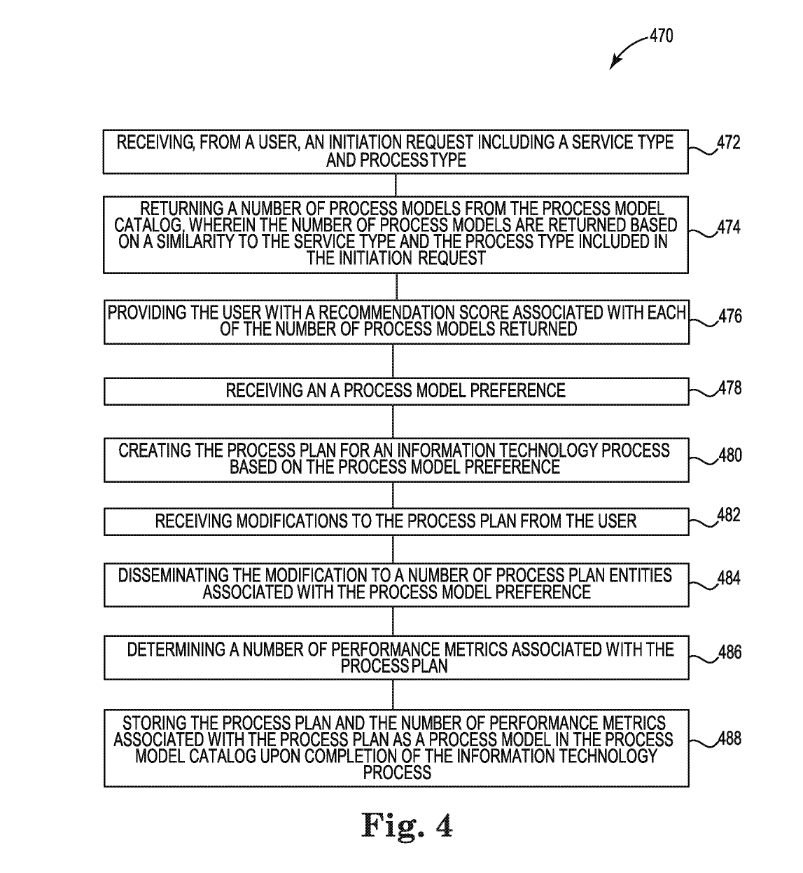

FIG. 4 illustrates a flow chart of an example of a method 470 for developing a process model catalog for IT operations management. At 472, the method 470 can include receiving, from an IT operations user, an initiation request including a service type and process type.

At 474, the method 470 can include returning a number of process models from the process model catalog, wherein the number of process models are returned based on a similarity to the service type and the process type included in the initiation request.

At 476, the method 470 can include providing the user with a recommendation score associated with each of the number of process models returned. The recommendation score can be based on a level of similarity between a first tag associated with the initiation request and a second tag associated with the process model being scored.

The recommendation score can be based on a number of performance metrics. The number of performance metrics can include at least one of a number of times the process plan has been utilized, a number of times the process plan was modified (e.g., manually by an IT operations user), a portion of times the process plan has been utilized successfully for its associated model (e.g., a percentage of times that all of the tasks of a process plan have been completed successfully completing the IT operation for which the process model was intended), an amount of time the process plan has historically taken to complete, and/or an overall score associated with a plurality of the performance metrics.

At 478, the method 470 can include receiving a process model preference. The process model preference can be a selection of an existing process model of the process model catalog or an indication to create a process plan (e.g., a blank process plan) without specifying an existing process model.

At 480, the method 470 can include creating the process plan for an information technology process based on the process model preference. For example, deriving the tasks, dependencies, and/or data fields of a process plan from a process model or generating a blank process plan.

At 482, the method 470 can include receiving modifications to the process plan from the user. For example, receiving modifications to the process plan entities.

At 484, the method 470 can include disseminating the modification to a number of process plan entities associated with the process model preference. Process plan entities associated with the process model preference can include process model entities of the same process model and/or a different process model.

At 486, the method 470 can include determining a number of performance metrics associated with the process plan. The number of performance metrics can include a number of times the process plan has been utilized, a number of times the process plan was modified, a portion of times the process plan has been utilized successfully for its associated model, an amount of time the process plan has historically taken to complete, and/or an overall score associated with a plurality of the performance metrics.

At 488, the method 470 can include storing the process plan and the number of performance metrics associated with the process plan as a process model in the process model catalog upon completion of the information technology process.

In the detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be used and the process, electrical, and/or structural changes may be made without departing from the scope of the present disclosure.

In addition, the proportion and the relative scale of the elements provided in the figures are intended to illustrate the examples of the present disclosure, and should not be taken in a limiting sense. As used herein, the designators “N” and “M”, particularly with respect to reference numerals in the drawings, indicate that a number of the particular feature so designated can be included with a number of examples of the present disclosure. As used herein, “a” or “a number of” something can refer to one or more such things.

What is claimed:

1. A non-transitory computer readable medium storing instructions executable by a processing resource to:
provide a user with a recommendation of at least one of a number of process models returned from a model catalog based on an initiation request from the user;
create a process plan for an information technology process based on a process model preference indicated by the user in response to the recommendation;
receive a modification to the process plan from the user;
disseminate the modification to a number of process plan entities associated with the process model preference;
store the process plan in the model catalog upon completion of the process plan; and
determine a number of performance metrics associated with the process plan.

2. The medium of claim 1, wherein the initiation request includes a selection of a request type from a plurality of request types associated with the model catalog.

3. The medium of claim 1, wherein the recommendation is based on historical usage data of an existing process model of the number of process models from the model catalog.

4. The medium of claim 1, wherein the process plan includes a number of tasks, a number of dependencies, and a number of data fields associated with the preferred process model.

5. The medium of claim 1, wherein the process model preference includes an indication from the user to create the process plan without a specified process model of the number of process models.

6. The medium of claim 5, wherein the process plan includes a blank process plan and the modification to the process plan from a user includes addition of a number of tasks, a number of dependencies, and a number of data fields to the blank process plan.

7. The medium of claim 6, wherein to store the process plan includes to store the process plan as a new process model corresponding to a new initiation request type.

8. The medium of claim 1, wherein the instructions include instructions executable by the processing resource to:
update the process plan upon completion of the process plan, wherein the update includes modifying the process plan to reflect steps needed to complete the process plan in a future application of the process plan.

9. A system, comprising:
a provisioning engine to provide, based on an initiation request including a service type and a process type, a number of process models based on the service type and the process type, wherein each of the process models returned is associated with a score representing a respective fit with the initiation request;
a creation engine to create a process plan for an information technology process based on a process model preference indicated by the user in response to providing the number of process models;
a modification engine to receive modifications to the process plan from the user;
a dissemination engine to disseminate the modification to a number of process plan entities associated with the process model preference;
a storage engine to store the process plan upon completion of the process plan; and
a scoring engine to determine a number of performance metrics associated with the process plan.

10. The system of claim 9, wherein the performance metric associated with the process plan can be updated each time the process plan is utilized.

11. The system of claim 10, wherein the process plan is flagged for a modification when its associated number of performance metrics fall below a pre-determined threshold.

12. The system of claim 11, wherein the process plan is modified based on the associated number of performance metrics.

13. A method for developing a process model catalog for operations management comprising:
receiving, from a user, an initiation request including a service type and process type;
returning a number of process models from the process model catalog, wherein the number of process models are returned based on a similarity to the service type and the process type included in the initiation request;
providing the user with a recommendation score associated with each of the number of process models returned;
receiving a process model preference;
creating the process plan for an information technology process based on the process model preference;
receiving modifications to the process plan from the user;
disseminating the modification to a number of process plan entities associated with the process model preference;
determining a number of performance metrics associated with the process plan; and
storing the process plan and the number of performance metrics associated with the process plan as a process model in the process model catalog upon completion of the information technology process.

14. The method of claim 13, wherein the recommendation score is based on:
a level of similarity between a first tag associated with the initiation request and
a second tag associated with a respective one of the number of process models.

15. The method of claim 13, wherein the recommendation score is based on the number of performance metrics.

16. The method of claim 15, wherein the performance metrics include at least one of:
a number of times the process plan has been utilized;
a number of times the process plan was modified;
a portion of times the process plan has been utilized successfully for its associated model;
an amount of time the process plan has historically taken to complete; and
an overall score associated with a plurality of the performance metrics.
